(19) United States
(12) Patent Application Publication
(10) Pub. No.: US 2013/0184896 A1
(43) Pub. Date: Jul. 18, 2013

(54) VEHICLE TRACKING MONITOR

(71) Applicant: Meiping ZHENG, Guangzhou (CN)

(72) Inventor: Meiping ZHENG, Guangzhou (CN)

(21) Appl. No.: 13/369,779

(22) Filed: Feb. 9, 2012

(30) Foreign Application Priority Data
Jan. 13, 2012 (CN) 201220017514.4

(51) Int. Cl. G06F 17/00

(52) U.S. Cl. 701/1

(57) ABSTRACT

The utility model discloses a vehicle tracking monitor, mainly comprising a master control unit, a power supply module, a GPS module and a GSM module, wherein the input end of the power supply module is electrically connected to a cigar lighter port on a vehicle and the output end thereof is connected with the master control unit; one end of the GPS module has a radio connection with a satellite, and the other end is connected with the master control unit for data transmission; one end of the GSM module has a radio connection with a computer server or a mobile phone, and the other end thereof is connected with the master control unit for data transmission.

### BACKGROUND OF THE INVENTION

1. Technical Field

The utility model relates to the technical field of accessories of traffic tools, such as vehicles, ships, trains, etc., and in particular to a vehicle tracking monitor.

2. Description of Related Art

The existing vehicle tracking monitor has the following defects: the working power is supplied via a power cord and cannot be obtained by being directly inserted into a cigar lighter port on a vehicle, which is very inconvenient; the vehicle state, such as collision, emergency brake, etc., cannot be judged; meanwhile, the existing products have no function of communication with two parties. Therefore, the existing vehicle tracking monitor fails to the meet the multifunctional use requirements of users.

### BRIEF SUMMARY OF THE INVENTION

To solve the technical problems in the prior art, the utility model aims to provide a vehicle tracking monitor which obtains the working power by being directly inserted into the cigar lighter port and has the functions of judging the vehicle state, conducting communication with two parties, etc.

To fulfill the mentioned aim, the utility model adopts the following technical scheme:

A vehicle tracking monitor mainly comprises a master control unit, a power supply module, a GPS module and a GSM module, wherein the input end of the power supply module is electrically connected to a cigar lighter port in a vehicle and the output end thereof is connected with the master control unit; one end of the GPS module has a radio connection with a satellite, and the other end is connected with the master control unit for data transmission; one end of the GSM module has a radio connection with a computer server or a mobile phone, and the other end thereof is connected with the master control unit for data transmission.

Preferably, the vehicle tracking monitor also comprises a standby lithium battery which is electrically connected with a power module.

Preferably, the vehicle tracking monitor also comprises an FM transceiver module, a microphone and operating keys for communication with an FM radio to transmit acoustic information; the operating keys are located on the vehicle tracking monitor; one end of the FM transceiver module is connected with the master control unit for data transmission, while the other end has a radio connection with an vehicle FM radio installed in the vehicle; the microphone is connected with the GSM module for data transmission.

Preferably, the vehicle tracking monitor also comprises a 3D acceleration sensor which is connected with the master control unit for data transmission.

Preferably, the vehicle tracking monitor also comprises a shock sensor and a buzzer, wherein both the shock sensor and the buzzer are connected with the master control unit for data transmission.

Preferably, the vehicle tracking monitor also comprises an LED module which is connected with the master control unit for data transmission.

Preferably, the vehicle tracking monitor also comprises a FLASH module which is connected with the master control unit for data transmission.

Preferably, the GSM module is also capable of having radio connection with an LBS (Location Based Service) station.

Preferably, the vehicle tracking monitor also comprises a USB interface through which the master control unit is connected with another computer server for data transmission.

Compared with the prior art, the utility model has the following advantages:

The vehicle tracking monitor obtains working power after being inserted into the cigar lighter port, acquires the vehicle state via a 3D acceleration sensor, and conducts the function of radio communication with the mobile phone of the opposite party via the FM transceiver module, the operating keys and the microphone, to meet the use requirements of the users; the GPS module and the GSM module are used in combination to make the vehicle trackable; the combination of the shock sensor and the buzzer conducts the alarming function to realize the functional use of the vehicle tracking monitor; the GSM module and the LBS station are connected to acquire the LBS information of the vehicle to ensure that the LBS information is acquired, so as to conduct the vehicle tracking function in case of no GPS signal (which means the GSP module fails to acquire the satellite location information), which is safer and more reliable.

The utility model is further described in detail by combining the attached drawings and the embodiments.

### BRIEF DESCRIPTION OF THE SEVERAL VIEWS OF THE DRAWINGS

FIG. 1 is a structural view of a preferable embodiment of the vehicle tracking monitor of the utility model.

### DETAILED DESCRIPTION OF THE INVENTION

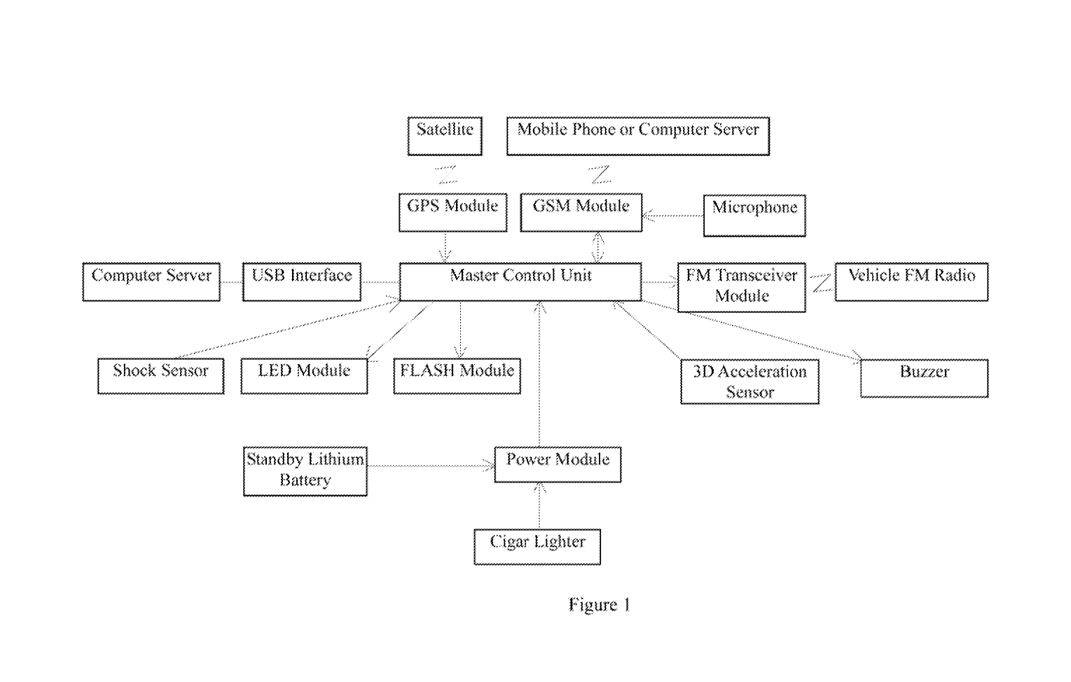

As shown in FIG. 1, the vehicle tracking monitor mainly comprises a master control unit, a power supply module, a GPS module and a GSM module, wherein the input end of the power supply module is electrically connected to a cigar lighter port on a vehicle and the output end thereof is connected with the master control unit; one end of the GPS module has a radio connection with a satellite, and the other end is connected with the master control unit for data transmission; one end of the GSM module has a radio connection with a computer server or a mobile phone, and the other end thereof is connected with the master control unit for data transmission.

The vehicle tracking monitor is capable of conveniently obtaining working power from the master control unit by directly inserting the power module into the cigar lighter port, receives the satellite location information via the GPS module, and transmits the satellite location information to the computer server or the mobile phone by the GSM module according to set time, so that the user is able to acquire the satellite location information of the vehicle to realize vehicle tracking.

Specifically, the vehicle tracking monitor also comprises a standby lithium battery which is electrically connected with a power module.

Specifically, the vehicle tracking monitor also comprises an FM transceiver module, a microphone and operating keys for communication with the FM radio to transmit acoustic information; the operating keys are located on the vehicle tracking monitor; one end of the FM transceiver module is connected with the master control unit for data transmission, while the other end has a radio connection with an vehicle FM radio installed in the vehicle; the microphone is connected with the GSM module for data transmission to realize communication between the two parties. The concrete operation is as follows: the user pre-stores a telephone number in the master control unit and calls the mobile phone of the opposite party via the operating keys and the GSM module. When the call is answered, confirm the reception of the call with the operating key. After the vehicle tracking monitor receives the call from the opposite party, the FM transceiver module transmits the audio information obtained by the GSM module to the vehicle FM radio and play the audio information via the loudspeaker of the vehicle FM radio. The acoustic pickup is realized by the microphone. The user is only required to speak to the microphone, and then the latter transmits the sound to the mobile phone of the opposite party via the GSM module, which is very convenient.

Specifically, the vehicle tracking monitor also comprises a 3D acceleration sensor which is connected with the master control unit for data transmission to acquire the vehicle state (for example, collision, emergency brake, etc.). Meanwhile, the vehicle tracking monitor transmits the acquired vehicle state to the computer server or the mobile phone via the GSM module, so the user is able to judge the vehicle state.

Specifically, the vehicle tracking monitor also comprises a shock sensor and a buzzer, wherein both the shock sensor and the buzzer are connected with the master control unit for data transmission. Once the shock sensor detects that the motion state of the vehicle tracking monitor is turned from the static state into the moveable state, the vehicle tracking monitor sends an alarm message to the computer server or the mobile phone via the GSM module to realize an antitheft alarm; when the vehicle goes too quickly, the buzzer will give an alarm.

The master control unit is also able to compute the satellite location information receiving rate of the GPS module to give an over-speed alarm, the user is capable of setting an electronic fence in the master control unit, and when it is found that the vehicle tracking monitor is out of the scope of the electronic fence after comparing the satellite location information, the alarm message is reported to the computer server or the mobile phone via the GSM module.

Meanwhile, when the vehicle tracking monitor is removed from the cigar light port, the buzzer will also give an alarm. Because the standby lithium battery built into the vehicle tracking monitor has a small capacity, when the vehicle tracking monitor is inserted into the cigar lighter, the master control unit detects the power supply and makes the vehicle tracking monitor work normally; but when the vehicle tracking monitor is removed from the cigar lighter, the master control unit detects no power supply and fails to make the vehicle tracking monitor work normally; at this moment, the standby lithium battery supplies power to the buzzer to give an alarm until the power of the standby lithium battery is exhausted.

Furthermore, the GSM module is the GSM module from the UBLOX company, capable of detecting whether or not the GSM signal has interference. In case there is interference, the information data, such as the satellite location, is stored automatically, and when the interference is eliminated, the alarm message and the stored information data are immediately transmitted to the computer server or the mobile phone.

Specifically, the vehicle tracking monitor also comprises an LED module which is connected with the master control unit for data transmission.

Specifically, the vehicle tracking monitor also comprises a FLASH module which is connected with the master control unit for data transmission to store the information data.

Specifically, the GSM module is also capable of being wirelessly connected with an LBS (location based service) station (not shown in the figure). In case of no GPS signal (which means the GPS module fails to the acquire the satellite location information), the LBS information can still be acquired from the LBS (Location Based Service) station and then transmitted to the computer server or the mobile phone via the GSM module to conduct the vehicle tracking function, which is safer and more reliable.

Specifically, the vehicle tracking monitor also comprises a USB interface. The master control unit is connected with another computer server for data transmission via the USB interface for four purposes: 1. connect with another computer server to update the program of the vehicle tracking monitor. 2. configure the parameters of the vehicle tracking monitor via the software configured in the another computer server; 3. transmit such data the satellite location information, which is acquired by the GPS module, and the vehicle state, which is acquired by the 3D acceleration sensor, to another computer server via the USB interface and a connecting line, so as to realize the wire connection between the vehicle tracking monitor and the computer server. 4. detect the hardware, wherein a detection command is sent from the USB interface and the vehicle tracking monitor performs automatic detection and outputs the detection result via the USB interface.

Skilled persons in this field would be able to provide all kinds of changes and transformations which shall be within the protection scope of the claims of the utility model according to the mentioned technical schemes and conception.

What is claimed is:

1. A vehicle tracking monitor, mainly comprising a master control unit, a power supply module, a GPS module and a GSM module, wherein the input end of the power supply module is electrically connected to a cigar lighter port on a vehicle, and the output end thereof is connected with the master control unit; one end of the GPS module has a radio connection with a satellite, and the other end is connected with the master control unit for data transmission; one end of the GSM module has a radio connection with a computer server or a mobile phone, and the other end thereof is connected with the master control unit for data transmission.

2. The vehicle tracking monitor according to claim 1, characterized in that the vehicle tracking monitor also comprises a standby lithium battery which is electrically connected with a power module.

3. The vehicle tracking monitor according to claim 2, characterized in that the vehicle tracking monitor also comprises an FM transceiver module, a microphone, and operating keys for communication with an FM radio to transmit acoustic information; the operating keys are located on the vehicle tracking monitor; one end of the FM transceiver module performs data transmission and is connected with the master control unit, while the other end has a radio connection with an vehicle FM radio installed on the vehicle; the microphone is connected with the GSM module for data transmission.

4. The vehicle tracking monitor according to claim 3, characterized in that the vehicle tracking monitor also comprises a 3D acceleration sensor which is connected with the master control unit for data transmission.

5. The vehicle tracking monitor according to claim 4, characterized in that the vehicle tracking monitor also comprises a shock sensor and a buzzer, wherein both the shock sensor and the buzzer are connected With the master control unit for data transmission.

6. The vehicle tracking monitor according to claim 5, characterized in that the vehicle tracking monitor also comprises an LED module which is connected with the master control unit for data transmission.

7. The vehicle tracking monitor according to claim 6, characterized in that the vehicle tracking monitor also comprises a FLASH module which is connected with the master control unit for data transmission.

8. The vehicle tracking monitor according to any one of claims 1 to 7, characterized in that the GSM module is also capable of having radio connection with an LBS station.

9. The vehicle tracking monitor according to claim 8, characterized in that the vehicle tracking monitor also comprises a USB interface through which the master control unit is connected with another computer server for data transmission.
